(19) United States
(12) Patent Application Publication
(10) Pub. No.: US 2008/0010145 A1
(43) Pub. Date: Jan. 10, 2008

(54) Method of promotion

(75) Inventor: Nan-Ching Ou, Taipei (TW)

Correspondence Address: BACON & THOMAS, PLLC, 625 SLATERS LANE, FOURTH FLOOR, ALEXANDRIA, VA, 22314, US

(73) Assignee: KEEPWELL DIGITAL TECH., Taipei (TW)

(21) Appl. No.: 11/482,721

(22) Filed: Jul. 10, 2006

(51) Int. Cl. G06Q 30/00

(52) U.S. Cl. 705/14

(57) ABSTRACT

A method of promotion is applied in a server computer that has at least one promotional advertisement proposed by an advertiser and a database having data of members, and the method has steps of (a) charging a budget and a maintenance fee from the advertiser, (b) disseminating the promotional advertisement to multiple recipients by the members before the promotional advertisement expires, (c) determining whether the promotional advertisement is successfully accepted by the recipients before the promotional advertisement expires, (d) appropriating a bonus from the budget for the member when the promotional advertisement promoted by the member is successfully accepted by the recipients and (e) refunding the remaining budget to the advertiser after the promotional advertisement expires.

### BACKGROUND OF THE INVENTION

1. Field of the Invention

The present invention relates to a method, and more particularly to a method of promotion, which ensures the gained advertising effect and the advertising cost on a promotion being balanced.

2. Description of Related Art

Advertisers promote a product by advertising the product in the mass media, such as TV programs, newspapers, magazines or the like. The advertiser pays advertisement fees to the companies of the mass media for its advertisements to be published. However, the advertising companies do not guarantee their clients the advertising effects.

To overcome the shortcomings, the present invention provides a method of promotion to mitigate or obviate the aforementioned problems.

### SUMMARY OF THE INVENTION

The main objective of the invention is to provide a method of promotion that ensures the gained advertising effect and the advertising cost on a promotion being balanced.

A method of promotion in accordance with the present invention is applied in a server computer that has at least one promotional advertisement proposed by an advertiser and a database having data of members, and the method comprises steps of (a) charging a budget and a maintenance fee from the advertiser, (b) disseminating the promotional advertisement by the members to multiple recipients before the promotional advertisement expires, (c) determining whether the promotional advertisement is successfully accepted by the recipients before the promotional advertisement expires, (d) appropriating a bonus from the budget for the member when the promotional advertisement promoted by the member is successfully accepted by the recipients and (e) refunding the remaining budget to the advertiser after the promotional advertisement expires.

Other objectives, advantages and novel features of the invention will become more apparent from the following detailed description when taken in conjunction with the accompanying drawings.

### BRIEF DESCRIPTION OF THE DRAWINGS

FIGS. 1A and 1B show a flow chart of a first embodiment of a method in accordance with the present invention.

### DETAILED DESCRIPTION OF PREFERRED EMBODIMENT

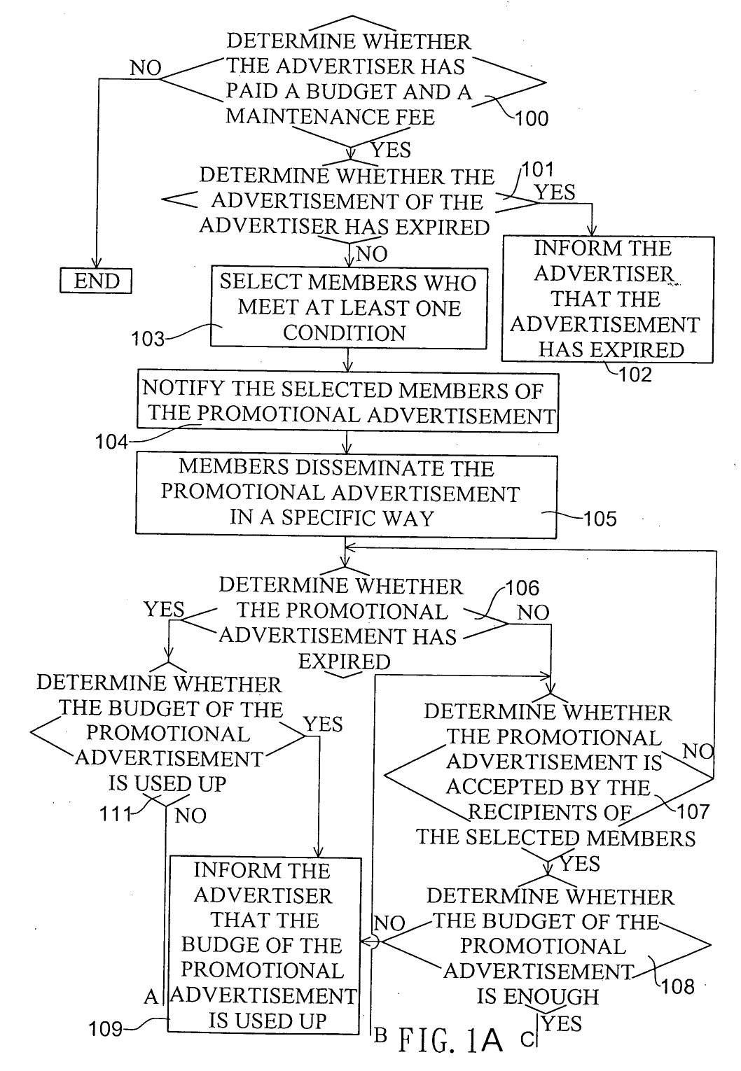

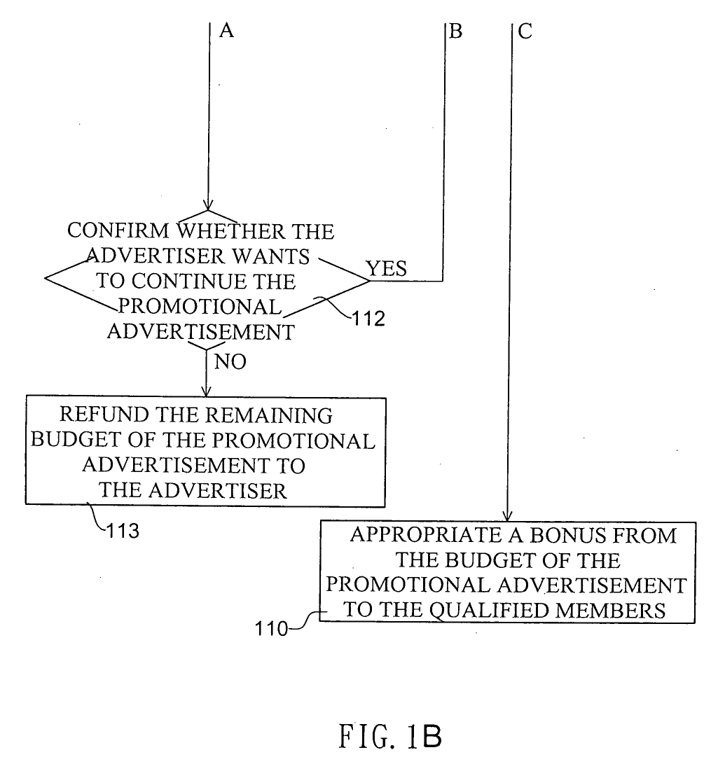

With reference to FIG. 1, a method of promotion in accordance with the present invention is applied in a server computer that has at least one promotional advertisement proposed by an advertiser and a database having data of members. The method comprises steps of (a) charging a budget and a maintenance fee from the advertiser, (b) determining whether an advertisement of the advertiser expires, (c) optionally selecting suitable members that have membership before a promotional advertisement expires, (d) optionally notifying the selected members, (e) disseminating the promotional advertisements to multiple recipients by the members, (f) determining whether the promotional advertisements successfully accepted by the recipients before the promotional advertisement expires, (g) appropriating a bonus from the budget of the promotional advertisement for the member when the promotional advertisement promoted by the member is successfully accepted by the recipients and (h) refunding the remaining budget to the advertiser after the promotional advertisement expires.

The step of charging a budget from the advertiser comprises determining whether or not the advertiser pays a budget and a maintenance fee (100). The maintenance fee can be 20% of the budget.

If the advertiser has paid the budget and the maintenance fee, determine whether the advertisement of the advertiser expires (101) and inform the advertiser when the advertisement expires (102).

If the advertisement has not expired, select members who meet at least one condition (103). The conditions may be “resident region of the members”, “age of the members”, “gender of the members”, “income of the members”, “level of education of the members” or the like.

When the selected members for the promotional advertisement are determined, notify the selected members of the promotional advertisement (104).

When the selected members are notified of the promotional advertisement, the members disseminate the promotional advertisement in a specific way (105). The members can establish personal websites containing a linking address of the promotional advertisement and advertise the personal websites to their recipients, or the members can send email attaching a linking address of the promotional advertisement to their recipients.

When the selected members disseminate the promotional advertisement to the recipients, once again determine whether or not the promotional advertisement expires (106). If the promotional advertisement has not expired, determine whether or not the promotional advertisement is accepted by the recipients belonging to the selected members (107). The processes to determine whether the recipients have accepted the promotional advertisement are as follows.

1. Determine whether or not the recipients indeed have opened the email of the promotional advertisement, wherein the email addresses are checked to avoid possible duplicate recipients.

2. Determine whether or not the recipients have actually linked to the promotional advertisement from the email or the personal websites of the selected members, wherein the IP addresses corresponding to the recipients are checked to avoid possible duplicate recipients.

3. Determine whether or not the recipients have successfully linked to the promotional advertisement, and determine the number of times of successful linkage to the promotional advertisement exceeds a limited value, wherein the IP addresses corresponding to the recipients are checked to avoid possible duplicate recipients.

4. Determine whether or not the recipients have finished an on-line activity corresponding to the promotional advertisement, such as an on-line transaction, an on-line registration, an on-line voting, a download of a discount coupon, filling out a questionnaire, playing a game, an upload of an essay, an upload of photos, an upload of graphics, an upload of videos or the like, wherein the IP addresses corresponding to the recipients are checked to avoid possible duplicate recipients.

The advertiser can choose any process above or any of their combination to determine whether the recipients have accepted the promotional advertisement. When each process or any process in the combination of the processes above is accomplished, determine whether or not the budget of the promotional advertisement is enough (108), inform the advertiser when the budget of the promotional advertisement is used up (109) and appropriate a bonus from the budget of the promotional advertisement for the qualified members that have had successful recipients (110). For example, if the advertiser decides a combination including processes 2 to 4, the steps (108)˜(110) will go on when each process in the combination is accomplished.

When the promotional advertisement expires, determine whether or not the budget of the promotional advertisement is used up (111) and confirm whether or not the advertiser wants to continue the promotional advertisement (112). If the advertiser wants to continue the promotional advertisement, go back to the step (107). If the advertiser decides to suspend the promotional advertisement, refund the remaining budget of the promotional advertisement to the advertiser (113).

Such a method charges a budget from the advertiser in advance and then the members disseminate the promotional advertisement. When the promotional advertisement is successfully promoted, the members will be rewarded with a bonus from the budget. If the budget remains the balance after the promotional advertisement has expired, the remaining budget will be refunded to the advertiser.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A method of promotion being applied in a server computer that has at least one promotional advertisement proposed by an advertiser and a database having data of members and comprising steps of:
charging a budget and a maintenance fee from the advertiser;
disseminating the promotional advertisement by the members to multiple recipients before the promotional advertisement expires;
determining whether the promotional advertisement is successfully accepted by the recipients before the promotional advertisement expires;
appropriating a bonus from the budget of the promotional advertisement for the member when the promotional advertisement promoted by the member is successfully accepted by the recipients; and
refunding the remaining budget to the advertiser after the promotional advertisement expires.

2. The method as claimed in claim 1, wherein the maintenance fee is a proportion of the budget.

3. The method as claimed in claim 1, wherein the members establish personal websites containing a linking address of the promotional advertisement to disseminate the promotional advertisement.

4. The method as claimed in claim 1, wherein the members send email attaching a linking address of the promotional advertisement to the recipients to disseminate the promotional advertisement.

5. The method as claimed in claim 3, wherein the promotional advertisement is further disseminated by the members who send emails attaching a linking address of the promotional advertisement to their recipients.

6. The method as claimed in claim 3, wherein the step of determining whether the promotional advertisement is successfully accepted by the recipients is to determine whether or not the recipients have actually linked to the promotional advertisement, wherein the IP addresses corresponding to the recipients are checked to avoid possible duplicate recipients.

7. The method as claimed in claim 3, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients; and
determining whether or not the number of times of successful linkage to the promotional advertisement by the recipients exceeds a limited value, wherein the IP addresses corresponding to the recipients are checked to avoid possible duplicate recipients; and
the step of appropriating a bonus for the member proceeds when any process in the step of determining whether the promotional advertisement is successfully accepted is accomplished.

8. The method as claimed in claim 3, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member when any process in the step of determining whether the promotional advertisement is successfully accepted is accomplished.

9. The method as claimed in claim 3, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients;
determining whether or not the number of times of successful linkage to the promotional advertisement by the recipients exceeds a limited value, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member when any process in the step of determining whether the promotional advertisement is successfully accepted is accomplished.

10. The method as claimed in claim 4, wherein the step of determining whether the promotional advertisement is successfully accepted by the recipients is to determine whether or not the recipients have indeed opened the email of the promotional advertisement, wherein the email addresses are checked to avoid possible duplicate recipients.

11. The method as claimed in claim 4, wherein the step of determining whether the promotional advertisement is successfully accepted by the recipients is to determine whether or not the recipients have actually linked to the promotional advertisement, wherein the IP addresses corresponding to the recipients are checked to avoid possible duplicate recipients.

12. The method as claimed in claim 4, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients; and
determining whether or not the recipients have actually linked to the promotional advertisement, wherein the IP addresses corresponding to the recipients are checked to avoid possible duplicate recipients; and
the step of appropriating a bonus for the member proceeds when any process in the step of determining whether the promotional advertisement is successfully accepted is accomplished.

13. The method as claimed in claim 4, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients;
determining whether or not the recipients have actually linked to the promotional advertisement, wherein the IP addresses corresponding to the recipients are checked to avoid possible duplicate recipients; and
determining whether or not the number of times of successful linkage to the promotional advertisement by the recipients exceeds a limited value, wherein the IP addresses corresponding to the recipients are checked to avoid possible duplicate recipients; and
the step of appropriating a bonus for the member proceeds when any process in the step of determining whether the promotional advertisement is successfully accepted is accomplished.

14. The method as claimed in claim 4, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients;
determining whether or not the recipients have actually linked to the promotional advertisement, wherein the IP addresses corresponding to the recipients are checked to avoid possible duplicate recipients;
determining whether or not the number of times of successful linkage to the promotional advertisement by the recipients exceeds a limited value, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member proceeds when any process in the step of determining whether the promotional advertisement is successfully accepted is accomplished.

15. The method as claimed in claim 4, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients;
determining whether or not the number of times of successful linkage to the promotional advertisement by the recipients exceeds a limited value, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member when any process in the step of determining whether the promotional advertisement is successfully accepted is accomplished.

16. The method as claimed in claim 4, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member proceeds when any process in the step of determining whether the promotional advertisement is successfully accepted is accomplished.

17. The method as claimed in claim 4, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients; and
determining whether or not the number of times of successful linkage to the promotional advertisement by the recipients exceeds a limited value, wherein the IP addresses corresponding to the recipients are checked to avoid possible duplicate recipients; and
the step of appropriating a bonus for the member proceeds when any process in the step of determining whether the promotional advertisement is successfully accepted is accomplished.

18. The method as claimed in claim 4, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member when any process in the step of determining whether the promotional advertisement is successfully accepted is accomplished.

19. The method as claimed in claim 4, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients;
determining whether or not the number of times of successful linkage to the promotional advertisement by the recipients exceeds a limited value, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member when any process in the step of determining whether the promotional advertisement is successfully accepted is accomplished.

20. The method as claimed in claim 5, wherein the step of determining whether the promotional advertisement is successfully accepted by the recipients is to determine whether or not the recipients have indeed opened the email of the promotional advertisement, wherein the email addresses are checked to avoid possible duplicate recipients.

21. The method as claimed in claim 5, wherein the step of determining whether the promotional advertisement is successfully accepted by the recipients is to determine whether or not the recipients have actually linked to the promotional advertisement, wherein the IP addresses corresponding to the recipients are checked to avoid possible duplicate recipients.

22. The method as claimed in claim 5, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients; and
determining whether or not the recipients have actually linked to the promotional advertisement, wherein the IP addresses corresponding to the recipients are checked to avoid possible duplicate recipients; and
the step of appropriating a bonus for the member proceeds when any process in the step of determining whether the promotional advertisement is successfully accepted is accomplished.

23. The method as claimed in claim 5, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients;
determining whether or not the recipients have actually linked to the promotional advertisement, wherein the IP addresses corresponding to the recipients are checked to avoid possible duplicate recipients; and
determining whether or not the number of times of successful linkage to the promotional advertisement by the recipients exceeds a limited value, wherein the IP addresses corresponding to the recipients are checked to avoid possible duplicate recipients; and
the step of appropriating a bonus for the member proceeds when any process in the step of determining whether the promotional advertisement is successfully accepted is accomplished.

24. The method as claimed in claim 5, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients;
determining whether or not the recipients have actually linked to the promotional advertisement, wherein the IP addresses corresponding to the recipients are checked to avoid possible duplicate recipients;
determining whether or not the number of times of successful linkage to the promotional advertisement by the recipients exceeds a limited value, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member proceeds when any process in the step of determining whether the promotional advertisement is successfully accepted is accomplished.

25. The method as claimed in claim 5, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients;
determining whether or not the number of times of successful linkage to the promotional advertisement by the recipients exceeds a limited value, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member when any process in the step of determining whether the promotional advertisement is successfully accepted is accomplished.

26. The method as claimed in claim 5, wherein
the step of determining whether the promotional advertisement is successfully accepted by the recipients comprises processes of
determining whether or not the recipients have indeed opened the email of the promotional advertisement, wherein the email addresses are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member proceeds when any process in the step of determining whether the promotional advertisement is successfully accepted is accomplished.

27. The method as claimed in claim 5, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients; and
determining whether or not the number of times of successful linkage to the promotional advertisement by the recipients exceeds a limited value, wherein the IP addresses corresponding to the recipients are checked to avoid possible duplicate recipients; and
the step of appropriating a bonus for the member proceeds when any process in the step of determining whether the promotional advertisement is successfully accepted is accomplished.

28. The method as claimed in claim 5, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member when any process in the step of determining whether the promotional advertisement is successfully accepted is accomplished.

29. The method as claimed in claim 5, wherein
the step of determining whether the promotional advertisement is successfully accepted by the recipients comprises processes of
determining whether or not the recipients have actually linked to the promotional advertisement, wherein the IP addresses corresponding to the recipients are checked to avoid possible duplicate recipients;
determining whether or not the number of times of successful linkage to the promotional advertisement by the recipients exceeds a limited value, wherein the IP addresses corresponding to the recipients are checked to avoid possible duplicate recipients; and
determining whether or not an on-line activity of the recipients is finished, wherein the IP addresses corresponding to the recipients are checked to avoid possible duplicate recipients; and
the step of appropriating a bonus for the member when any process in the step of determining whether the promotional advertisement is successfully accepted is accomplished.

30. The method as claimed in claim 8, wherein the on-line activity is an on-line transaction.

31. The method as claimed in claim 9, wherein the on-line activity is an on-line transaction.

32. The method as claimed in claim 14, wherein the on-line activity is an on-line transaction.

33. The method as claimed in claim 15, wherein the on-line activity is an on-line transaction.

34. The method as claimed in claim 16, wherein the on-line activity is an on-line transaction.

35. The method as claimed in claim 18, wherein the on-line activity is an on-line transaction.

36. The method as claimed in claim 19, wherein the on-line activity is an on-line transaction.

37. The method as claimed in claim 24, wherein the on-line activity is an on-line transaction.

38. The method as claimed in claim 25, wherein the on-line activity is an on-line transaction.

39. The method as claimed in claim 26, wherein the on-line activity is an on-line transaction.

40. The method as claimed in claim 28, wherein the on-line activity is an on-line transaction.

41. The method as claimed in claim 29, wherein the on-line activity is an on-line transaction.

42. The method as claimed in claim 1 further comprising steps of:
selecting suitable members having membership before the promotional advertisement expires and meeting at least one condition; and
notifying the selected members of the promotional advertisement.
